(19) United States
(12) Patent Application Publication
(10) Pub. No.: US 2008/0304674 A1
(43) Pub. Date: Dec. 11, 2008

(54) Hearing device test adapter

(75) Inventors: Wai Kit David Ho, Singapore (SG); Wee Haw Koo, Singapore (SG); Chee Hock Toh, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL INSTRUMENTS PTE. LTD.

(21) Appl. No.: 12/156,111

(22) Filed: May 29, 2008

(30) Foreign Application Priority Data
Jun. 5, 2007 (DE) 10 2007 026 116.2

(51) Int. Cl. H04R 29/00

(52) U.S. Cl. 381/60

(57) ABSTRACT

A hearing device test adapter is provided in order to connect a hearing device output to a test microphone in a soundproof manner. The hearing device test adapter has an expandable first section for enclosing one section of a hearing device shell or an earmold piece in a soundproof manner such that the sound output of the hearing device shell or of the earmold piece points to the tip of the first section. In addition, the hearing device test adapter has an expandable second section for enclosing a section of the test microphone in a soundproof manner, with the tip of the first section directly connecting to the second section and both being connected to one another via a sound transmission.

### CROSS REFERENCE TO RELATED APPLICATIONS

This application claims priority of German application No. 10 2007 026 116.2 DE filed Jun. 5, 2007, which is incorporated by reference herein in its entirety.

### FIELD OF INVENTION

The present invention relates to a hearing device test adapter for connecting a hearing device output to a test microphone unit in a soundproof manner.

### BACKGROUND OF INVENTION

Hearing devices are portable hearing apparatuses which are used to supply the hard-of-hearing. To accommodate the numerous individual requirements, different configurations of hearing devices such as behind-the-ear hearing devices (BTE), in-the-ear hearing devices (ITE), e.g. also concha hearing devices or completely-in-the-channel devices (CIC), are provided. The hearing devices listed by way of example are worn on the outer ear or in the auditory canal. Furthermore, bone conduction hearing aids, implantable or vibrotactile hearing aids are also available on the market. The damaged hearing is herewith either stimulated mechanically or electrically.

Essential components of the hearing devices include in principal an input converter, an amplifier and an output converter. The input converter is generally a receiving transducer, e.g. a microphone and/or an electromagnetic receiver, e.g. an induction coil. The output converter is mostly realized as an electroacoustic converter, e.g. a miniature loudspeaker, or as an electromechanical converter, e.g. a bone conduction receiver. The amplifier is usually integrated into a signal processing unit. This main configuration is shown in the example in FIG. 1 of a behind-the-ear hearing device. One or a number of microphones 2 for recording the ambient sound are incorporated in a hearing device housing 1 to be worn behind the ear. A signal processing unit 3, which is similarly integrated into the hearing device housing 1, processes the microphone signals and amplifies them. The output signal of the signal processing unit 3 is transmitted to a loudspeaker and/or receiver 4, which outputs an acoustic signal. The sound is optionally transmitted to the ear drum of the device wearer via a sound tube, which is fixed with an otoplastic in the auditory canal. The power supply of the hearing device and in particular of the signal processing unit 3 is supplied by a battery 5 which is likewise integrated into the hearing device housing 1.

Hearing devices are to be tested prior to their delivery and/or for adjustment purposes. To this end, they are usually provided in a testbox. They are connected there with their sound output to a test microphone in a soundproof manner with the aid of an adapter. A loudspeaker in the testbox generates a test sound, which a microphone of the hearing device to be tested receives. The recorded sound is processed further in the hearing device and the amplified output sound is received by the test microphone.

### SUMMARY OF INVENTION

While testing a hearing device, it is of primary importance for the hearing device output to be connected to the test microphone in a soundproof manner. Nowadays a coupler is used in many cases to ensure this, said coupler being filled with an adhesive material which can be used a number of times. This is pressed onto the shell of the ITE, the CIC or the earmold piece of a BTE in a soundproof manner. There thus only remains a sound tube from the sound exit of the hearing device through the coupler to the test microphone.

However, the skill of the acoustician is required to press the adhesive onto the hearing device shell and/or ear mold piece in such an airtight manner that no direct sound can leak into the test microphone on the hearing device shell from the testbox loudspeaker. Pressing the adhesive material also represents a labor-intensive and time-consuming procedure.

The publication U.S. Pat. No. 3,979,567 discloses a microphone coupling for a hearing device test system, in order to connect a hearing device and a microphone to one another. The microphone coupling is manufactured from a rigid, inflexible material, preferably aluminum. A non-hardening sealing material is used for acoustic sealing, e.g. a silicon plastic.

The object of the present invention thus consists in reducing the effort needed when coupling a hearing device to a test microphone.

This object is achieved in accordance with the invention by a hearing device test adapter for connecting a hearing device output to a test microphone unit in a soundproof manner, including a funnel-shaped, expandable first section for enclosing a section of a hearing device shell or an ear mold piece in a soundproof manner such that the sound output of the hearing device shell or of the ear mold piece points to the tip of the first section and a tubular, expandable second section for enclosing a section of the test microphone unit in a soundproof manner, with the tip of the first section directly connecting to the second section and both being connected to one another by means of a sound transmission.

The funnel-shaped expandable first section of the hearing device test adapter advantageously allows one part of a hearing device shell in particular to be enclosed in a soundproof manner, simply by pushing this into the funnel. The second likewise expandable tubular section guarantees the acoustic leak tightness compared with the test microphone and/or a corresponding coupler.

The second section preferably has a polygonal opening, i.e. the interior of the tubular section is approximately prism-shaped. The hearing device test adapter can thus be held on the test microphone and/or coupler in a rotationally secure manner, if the hearing device and/or ear mold piece is pushed into the funnel-shaped first section in a rotating fashion.

A further preferred embodiment consists in the first section being connected in one piece to the second section. This reduces the production costs of the adapter and also ensures the soundproofness between both sections.

The first and second section each advantageously consists of rubber or a rubbery plastic. The high elasticity of these materials provides for the necessary leak tightness.

As a whole, a hearing device test adapter set can be provided, which in addition to the hearing device test adapter has a similarly elastic plug for sealing a vent in the hearing device shell or the ear mold piece on the sound output side. This plug can be produced from the same elastic material as the hearing device test adapter. It is needed so that the vent of the hearing device to be tested and/or the otoplastic to be tested (ear mold piece) is sealed so that no direct sound can reach the test microphone through the vent from the test loudspeaker.

### BRIEF DESCRIPTION OF THE DRAWINGS

The present invention is described in more detail with reference to the appended drawings, in which;

FIG. 1 shows the basic design of a hearing device with its essential components;

FIG. 2 shows a drawing of a testbox, in which a CIC hearing device is inserted into an inventive adapter;

FIG. 3 shows an enlarged illustration of the inventive adapter with a CIC hearing device and a coupler in FIG. 2;

FIG. 4 shows the arrangement in FIG. 3 with a removed hearing device;

FIG. 5 shows the hearing device to be tested having a vent seal;

FIG. 6 shows the arrangement in FIG. 3 with an ITE hearing device to be tested and

FIG. 7 shows a top view, a longitudinal sectional view and a rear side view of an inventive adapter.

### DETAILED DESCRIPTION OF INVENTION

The exemplary embodiments illustrated in more detail below represent preferred embodiments of the present invention.

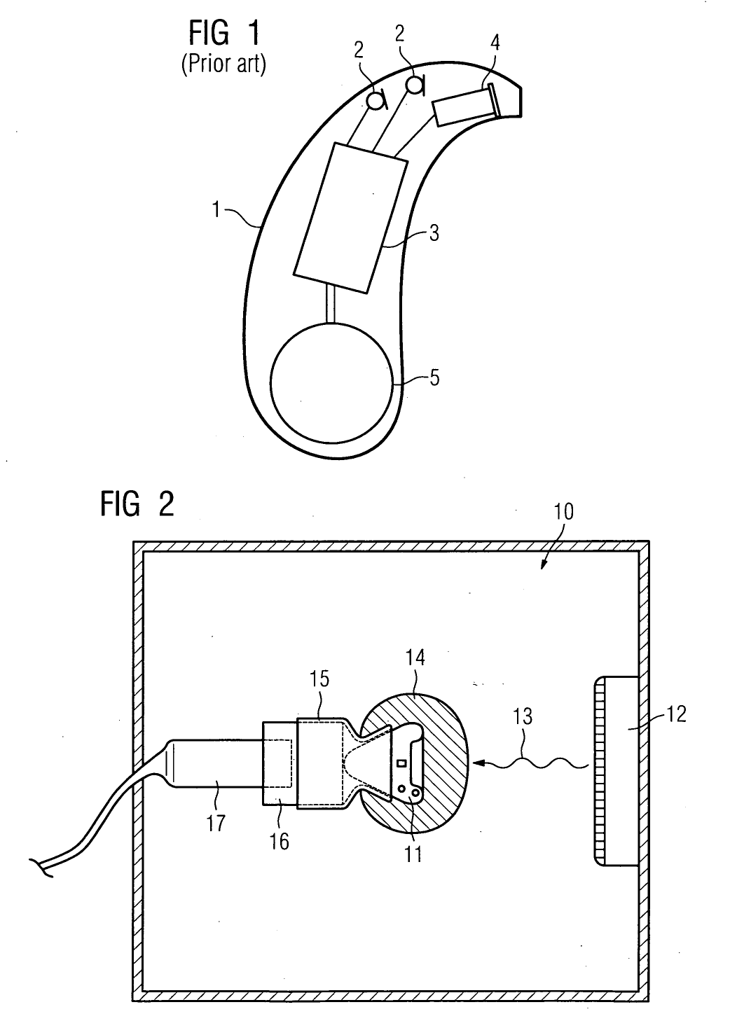

In accordance with the drawing in FIG. 2, a CIC hearing device 11 is subjected to a sound test in a testbox 10. A testbox loudspeaker 12, which generates a test sound 13, is located in the testbox 10. To ensure that the acoustic conditions are fulfilled for the test, the hearing device 11 to be tested is positioned on a so-called test spot 14. To this end, the hearing device 11 is held on a coupler 16 in a soundproof manner using an inventive rubber adapter 15. The coupler 16 plugs itself into a test microphone 17.

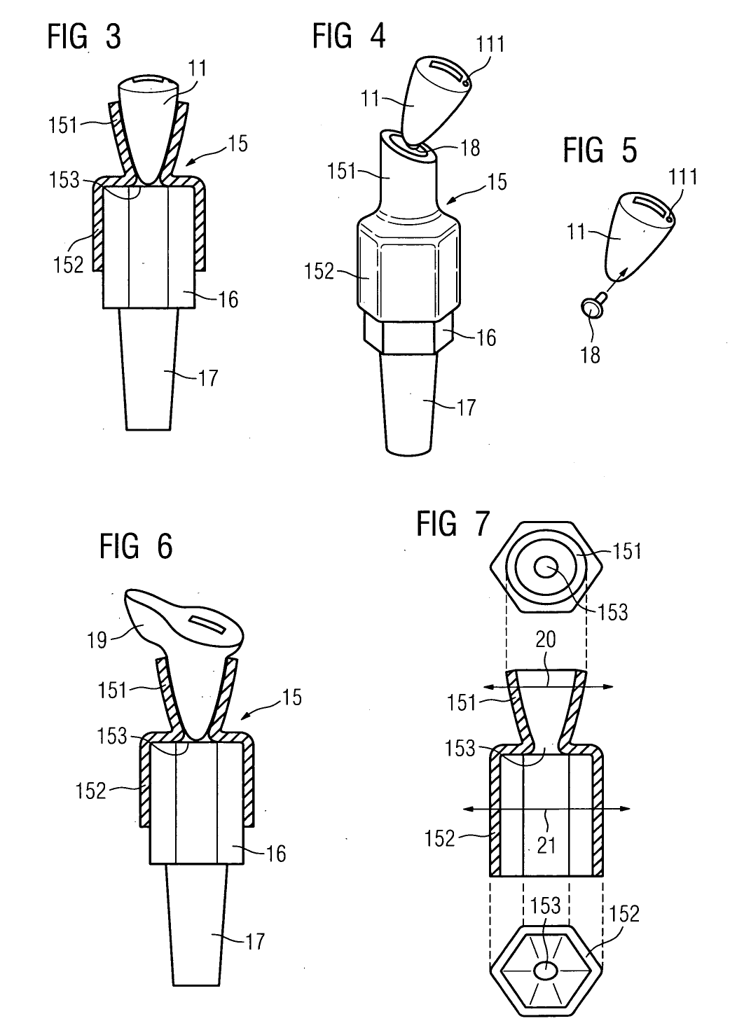

The hearing device test adapter 15 consists here of a rubber molded part, which can be seen more easily in the enlarged illustration in FIG. 3. It is essentially tubular and has a waist, which divides it into a first section 151 and a second section 152. FIG. 3 shows a longitudinal section of the two sections 151 and 152 which are connected in one piece with one another. The first section 151 is embodied in the manner of a funnel and is used to accommodate the hearing device 11, in this instance a CIC hearing device. Using its tip, the funnel-shaped first section 151 opens out into the second section 152 by way of a sound opening 153. This second section can be cylindrical or prism-shaped like the example in FIG. 3. The form of a hexagonal prism is selected in particular here. This form also has the coupler 16, which is enclosed in a soundproof manner by the second section of the hearing device test adapter 15. This ensures the soundproofness in a similar manner as in the first section 151 in that the adapter material can be expanded and can thus be drawn onto the approximately larger hearing device 11 and/or the approximately larger coupler 16 and produces the respective frictional connection.

To ensure increased rotational security, the second section 152 is, as mentioned, embodied here in the manner of a prism. If the hearing device 11 is then inserted into the funnel-shaped first section 151 by means of a rotary-push movement, the adapter 15 does not rotate on the coupler 16, which may be necessary for alignment purposes, but also improves the position of the adapter overall. FIG. 3 also shows the test microphone 17, onto which the coupler 16 is plugged or screwed in a soundproof manner.

FIG. 4 shows a side view of the arrangement of FIG. 3. The CIC hearing device 11 is removed here from the funnel-shaped first section 151 and/or is not reinserted into this section. Before the hearing device is namely plugged into the adapter 15, a vent 111 of the hearing device 11 is to be sealed with a plug 18 on the sound output side. This is the only way of ensuring that the sound of the test loudspeaker 12 does not reach the test microphone 17 through the vent 111. FIG. 5 shows this plug 18 when it is removed from the hearing device 11. Depending on the diameter of the vent 111, this plug 18 has different sizes. It nevertheless also consists of an elastic material, like for instance rubber, so that it can be easily introduced into the vent 111 and is automatically held here by means of friction.

A number of hearing device test adapters 15 which have differently shaped first sections 151 can be provided for one and the same coupler 16. The depth or opening width of the funnel can thus be different for instance. It is thus possible to insert differently shaped hearing devices 11 in a suitable manner, i.e. also sufficiently deep, into the first section 151. FIG. 6 illustrates by way of example that an ITE hearing device 19 can also be inserted into the first section 151 of the adapter 15.

FIG. 7 shows a longitudinal section of the inventive hearing device test adapter 15 in the center, thereabove in a top view of the side of the first section and therebelow a rear side view of the side of the second section 152. It is clear that the second section 152 is hexagonal in the axial projection. Furthermore, the drawings show that the first section is connected to the second section by means of a sound opening 153. This ensures that the sound generated by the hearing device 11, 19 can enter an opening of the coupler 16.

Furthermore, the arrows 20 and 21 indicate that the hearing device test adapter 15 can be expanded both in the region of the first section 151 as well as in the region of the second section 152 in order to nestle up against the body of the hearing devices 11, 19 and/or of the coupler 16 in a soundproof manner. As a result, the installation time of the hearing device in the test box and thus the total test time can be considerably reduced. Furthermore, the test results are clearly improved by means of the elastic hearing device test adapter, since a soundproof position of the hearing device on the coupler and/or on the test microphone can be better ensured.

1.-7. (canceled)

8. A hearing device test adapter that connects a hearing device output to a test microphone unit in a soundproof manner, comprising:
an expandable first section that encloses a section of a hearing device shell or an earmold piece in a soundproof manner such that the sound output of the hearing device shell or of the earmold piece points to the tip of the first section, the first section having a funnel-shape; and
and expandable second section that encloses a section of the test microphone unit in a soundproof manner, the second section having a tubular shape,
wherein the tip of the first section directly connects to the second section and both are connected to one another via a sound transmission, and
wherein the first section and the second section are formed from an elastic material.

9. The hearing device test adapter as claimed in claim 8, wherein the second section has a polygonal opening.

10. The hearing device test adapter as claimed in claim 8, wherein the first and second sections are formed as one piece.

11. The hearing device test adapter as claimed in claim 9, wherein the first and second sections are formed as one piece.

12. A hearing device test adapter that connects a hearing device output to a test microphone unit in a soundproof manner, comprising:
an expandable first section that encloses a section of a hearing device shell or an earmold piece in a soundproof manner such that the sound output of the hearing device shell or of the earmold piece points to the tip of the first section; and
an expandable second section that encloses one section of the test microphone unit in a soundproof manner, with
wherein the tip of the first section directly connects to the second section and both are connected to one another via a sound transmission.

13. The hearing device test adapter as claimed in claim 12, wherein the first section has a funnel shape.

14. The hearing device test adapter as claimed in claim 13, wherein the second section has a tubular shape.

15. The hearing device test adapter as claimed in claim 12, wherein the second section has a polygonal opening.

16. The hearing device test adapter as claimed in claim 14, wherein the second section has a polygonal opening.

17. The hearing device test adapter as claimed in claim 12, wherein the first and second sections are formed as one piece.

18. The hearing device test adapter as claimed in claim 14, wherein the first and second sections are formed as one piece.

19. The hearing device test adapter as claimed in claim 15, wherein the first and second sections are formed as one piece.

20. The hearing device test adapter as claimed in claim 12, wherein the first section and the second section are formed from an elastic material.

21. The hearing device test adapter as claimed in claim 14, wherein the first section and the second section are formed from an elastic material.

22. The hearing device test adapter as claimed in claim 15, wherein the first section and the second section are formed from an elastic material.
